(19) United States
(12) Patent Application Publication
(10) Pub. No.: US 2007/0214389 A1
(43) Pub. Date: Sep. 13, 2007

(54) JTAG power collapse debug

(76) Inventors: Matthew Levi Severson, Oceanside, CA (US); Kevin Charles Burke, Raleigh, NC (US); Philip Richard Pottier, San Diego, CA (US)

Correspondence Address: QUALCOMM INCORPORATED, 5775 MOREHOUSE DR., SAN DIEGO, CA, 92121, US

(21) Appl. No.: 11/370,696

(22) Filed: Mar. 7, 2006

(51) Int. Cl. G06F 11/00

(52) U.S. Cl. 714/30

(57) ABSTRACT

A method of performing a debug operation on a processor after a power collapse is provided. An idle state of the processor is detected during an execution mode of the processor. The idle state is determined to be associated with a power collapse event. A debug state of the processor is restored by loading debug registers within the processor during the execution mode.

### BACKGROUND

I. Field

The present disclosure generally relates to debug operations of software running on a processor. More particularly, the disclosure relates to a system and a method to perform debug operations of software running on a processor through a power collapse event.

II. Description of Related Art

Advances in technology have resulted in smaller and more powerful personal computing devices. For example, there currently exist a variety of portable personal computing devices, including wireless computing devices, such as portable wireless telephones, personal digital assistants (PDAs), and paging devices that are small, lightweight, and easily carried by users. More specifically, portable wireless telephones, such as cellular telephones and IP telephones, can communicate voice and data packets over wireless networks. Further, many such wireless telephones include other types of devices that are incorporated therein. For example, a wireless telephone can also include a digital still camera, a digital video camera, a digital recorder, and an audio file player. Also, such wireless telephones can include a web interface that can be used to access the Internet. As such, these wireless telephones include significant computing capabilities.

Typically, as these devices include greater functionality, more power is consumed by the various internal components that may be needed to support the various functions of the devices. Consequently, to save power during periods of non-use, mobile devices have incorporated various power saving techniques. There are three different modes that advanced RISC machines (ARM) processors can enter to conserve power that will suspend or prevent debug communication: an idle mode, a sleep mode, and a power collapse mode. During an idle mode, the ARM processor clock is stopped, but the rest of the chip remains powered. During sleep mode, the ARM processor clock is off, the reference clock is off, and the voltage level is reduced. During a power collapse, the ARM processor is powered down.

In any of these three power saving modes, the processor may be inaccessible because the ARM clock is not toggling. However, it is still necessary to debug software operating on the processors and cores of the device before and/or after the power collapse.

One potential method is to reboot the chip and to restore the register data as part of the reboot process. However, this method does not allow for debugging of the supervisor code, since the supervisor code is needed for the reboot process. Moreover, one or more of the registers may not be accessible for restoration during the reboot process. For example, a debug configuration register may be reset during a reboot process and making such a register accessible may provide a security hole. Typically, the debug configuration register cannot readily be restored.

Accordingly, it would be advantageous to provide an improved system and method for use in debugging cores and processors.

### SUMMARY

In one particular embodiment, a method of performing a debug operation on a processor after a power collapse is provided. An idle state of the processor is detected during an execution mode of the processor. The idle state is determined to be associated with a power collapse event. A debug state of the processor is restored by loading debug registers within the processor during the execution mode.

In a particular embodiment, a state of the processor is queried after detecting the idle state of the processor. Further, in a particular embodiment, a debug operation is executed that uses at least one of the restored debug registers. In another particular embodiment, the debug operation is one of a breakpoint and a watchpoint debug operation.

In a particular embodiment, the processor includes an ARM type of microprocessor core. In another particular embodiment, the idle state is detected when a processor clock of the processor is inactive. Further, in a particular embodiment, the idle state is determined to be associated with a power collapse event when the processor is in the idle state for at least 500 milliseconds. In another particular embodiment, a register scan is performed using a Joint Test Action Group (JTAG) debugger to detect the idle state of the processor. In yet another particular embodiment, at least one of the debug registers is a debug configuration register that is testable when the processor executes in a supervisor mode.

In still another particular embodiment, a resynchronized timing clock (RTCK) signal is evaluated in connection with detecting the idle state or in connection with detecting an end of the power collapse event. In a particular embodiment, an end of the power collapse event is detected prior to restoring the debug state.

In another particular embodiment, a method of performing a debug operation on a processor having a processor core is provided. An idle state of the processor core is detected during an execution mode of the processor. A request for a debug operation is provided while the processor is in the idle state. It is determined that the idle state is associated with a power collapse event by querying a state of the processor while the processor is halted. The method further includes entering into a Joint Test Action Group (JTAG) wait mode, detecting an end of the power collapse event, restoring a debug state of the processor by loading debug registers, detecting a debug acknowledge signal, and performing the debug operation that was requested.

In a particular embodiment, a power signal that is associated with power supplied to the processor is turned off before entering into the JTAG wait mode. In another particular embodiment, the method includes detecting expiration of a clock timer prior to detecting the idle state. In another particular embodiment, an input/output interface of the processor core is in a frozen condition prior to the end of the power collapse event.

In still another particular embodiment, a JTAG input/output interface of the processor core is frozen during the power collapse event and is unfrozen after detecting the end of the power collapse event. In another particular embodiment, the debug operation is one of a breakpoint and a watchpoint debug operation. In another particular embodiment, the processor is in the idle state for at least 500 milliseconds. In yet another particular embodiment, the method includes performing a register scan using a JTAG debug system to detect the idle state of the processor.

In another particular embodiment, a processor debugging device is disclosed and includes means for detecting an idle state of a processor, means for providing a request for a debug operation while the processor is in the idle state, means for determining that the idle state is associated with a power collapse event, means for detecting an end of the power collapse event and for restoring a debug state of the processor, and means for performing the debug operation that was requested.

In another particular embodiment, an integrated circuit includes a debug interface, a debug register, a modem power manager and a processor. The debug interface is adapted to receive instructions related to a debug operation. The debug register is adapted to store data related to the debug operation. The modem power manager is adapted to control a digital voltage level, to collapse the digital voltage level to conserve power during a period of processor inactivity, and to restore the digital voltage level when the period of processor inactivity is ended. The processor is responsive to the debug interface and to the modem power manager and is adapted to drive a power exit pin to a designated logic level in response to restoration of the digital voltage level.

In a particular embodiment, the data is restored to the debug register upon restoration of the digital voltage level. In another particular embodiment, a Joint Test Action Group (JTAG) interface is adapted to connect to a debug system. The processor is adapted to freeze a logic level of at least one pin of the JTAG interface in response to collapse of the digital voltage level. Further, in a particular embodiment, the processor is adapted to unfreeze the logic level of the at least one pin upon restoration of the digital voltage level.

In another particular embodiment, a debug system includes a debug interface, processor readable instructions, and a processor. The debug interface is adapted to connect to a target processor. The processor readable instructions define debug operations and define a user interface for user interactions. The processor is adapted to produce the user interface based on the processor readable instructions and to control the debug operations in response to the processor readable instructions. The processor is adapted to detect a power collapse state of the processor based on a change of state of a pin of the debug interface.

In a particular embodiment, the processor is adapted to store a state of the debug registers in the memory during the debug operations. The debug system is adapted to restore the state of the debug registers from the memory in response to the change of state. In another particular embodiment, the pin includes a clock pin, and the change of state includes a rising clock edge on the clock pin after a period of inactivity.

In a particular embodiment, a portable communication device includes a digital signal processor and a controller. The controller includes a modem power manager and a processor. The modem power manager is adapted to control a digital voltage level, to collapse the digital voltage level to conserve power during a period of processor inactivity, and to restore the digital voltage level when the period of processor inactivity is ended. The processor is responsive to the modem power manager and is adapted to control operation of a portion of the communication device. The processor includes debug functionality to provide a power collapse recovery indication in response to restoration of the digital voltage level from a collapsed power state.

In a particular embodiment, the controller and the digital signal processor are provided on an integrated circuit with test pins. Further, in another particular embodiment, the portable communication device includes an analog baseband processor, a stereo audio coder/decoder (CODEC), a radio frequency (RF) tranceiver, an RF switch and an RF antenna. The analog baseband processor is coupled to the digital signal processor. The stereo audio coder/decoder (CODEC) is coupled to the analog baseband processor. The radio frequency (RF) transceiver is coupled to the analog baseband processor. The RF switch is coupled to the RF transceiver. The RF antenna is coupled to the RF switch.

In a particular embodiment, a processor readable medium embodying executable instructions is provided to perform a debug operation on a processor. The executable instructions include instructions to detect an idle state of a processor during an execution mode of the processor, instructions to determine that the idle state is associated with a power collapse event, and instructions to restore a debug state of the processor by loading debug registers of the processor during the execution mode.

In another particular embodiment, the processor readable medium further includes instructions to query a state of the processor after detecting the idle state of the processor. In yet another particular embodiment, the processor readable medium further includes instructions to execute a debug operation that uses at least one of the debug registers. In another particular embodiment, the debug operation includes instructions to execute one of a breakpoint and a watchpoint debug operation. In yet another particular embodiment, the idle state is detected when a processor clock of the processor is inactive. In still another particular embodiment, the processor readable medium further includes instructions to perform a register scan using a Joint Test Action Group (JTAG) debug system to detect the idle state of the processor. In yet another particular embodiment, the processor readable medium further includes instructions to execute a supervisor mode to test a debug configuration register of the debug registers. In still another particular embodiment, the processor readable medium further includes instructions to detect an end of the power collapse event prior to restoring the debug state.

An advantage of one or more embodiments disclosed herein can include enabling debug operations to be performed during and after a power collapse event.

Another advantage of one or more embodiments disclosed herein can include performing debug operations through a power collapse and power recovery process without the addition of side-band signals.

Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a block diagram illustrating a debug architecture for an Advanced RISC machines (ARM) processor with a debug functionality;

FIG. 2 is a block diagram of an processor with a modem power manager;

FIG. 3 is a portion of a timing diagram illustrating an idle state, a sleep state, and a power collapse state with respect to a processor clock, a reference clock, and a power supply;

FIG. 4 is a flow diagram illustrating a method of restoring debug registers after a power collapse;

FIG. 5 is a flow diagram illustrating a method of detecting a power collapse of the processor and of restoring the debug data upon restoration of power to the processor;

FIG. 6 is a portion of a timing diagram illustrating a set of signals during several modes of operation of the processor;

FIG. 7 is a block diagram of a debug interconnection between the processor, the Joint Test Action Group (JTAG) interface, and a modem power manager (MPM);

FIG. 8 is a portion of a timing diagram illustrating a set of signals used to diagnose a power collapse state and to restore debug registers upon restoration of the power supply to the processor;

FIG. 9 is a general diagram of a portable communication device incorporating a processor with debug functionality and controllers including processors with debug functionality according to any of the FIGS. 1-8;

FIG. 10 is a general diagram of an exemplary cellular telephone incorporating several controllers, each of which may contain an ARM processor with debug functionality according to any of the FIGS. 1-8;

FIG. 11 is a general diagram of an exemplary wireless Internet Protocol telephone incorporating several controllers including processors with debug functionality according to any of the FIGS. 1-8;

FIG. 12 is a general diagram of an exemplary portable digital assistant incorporating several controllers including processors with debug functionality according to any of the FIGS. 1-8; and

FIG. 13 is a general diagram of an exemplary audio file player incorporating a controller including a processor with debug functionality according to any of the FIGS. 1-8.

### DETAILED DESCRIPTION

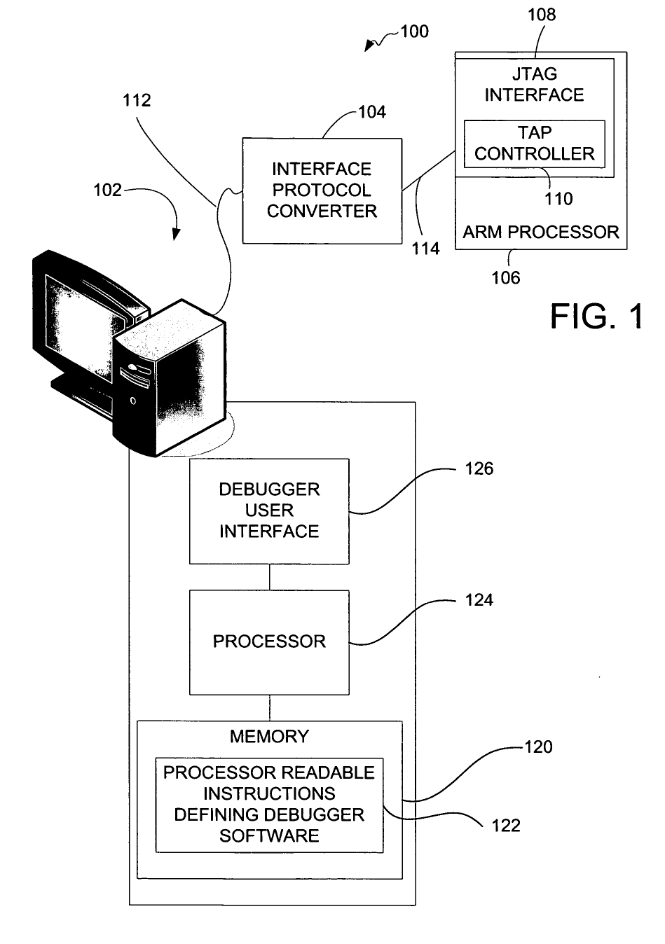

FIG. 1 is a block diagram illustrating a debug architecture 100 for a processor, such as an Advanced RISC machines (ARM) processor 106. The debug architecture 100 includes a host computer 102, an interface protocol converter 104, and a processor 106. The processor may be an ARM-type of microprocessor core or a processor having a processor core. The host computer 102 is illustrated as a computer workstation or desktop computer, but it should be understood that the computer 102 may be any processor-based device, including a portable computer, a hand-held computing device, a windows PC, a sun workstation, and the like. The host computer 102 is connected to the interface protocol converter 104 by a suitable interface 112, such as an RS232 interface, a parallel interface, or any other suitable interface. The interface protocol converter 104 is connected to the processor 106 via a suitable interface 114. A Joint Test Action Group (JTAG) interface 108 with a TAP controller 110 connects the processor 106 to the interface protocol converter 104 via the interface 114. Instructions that are sent from the host computer 102 via the interface 112 are converted to the interface signals of the processor 106 by the interface protocol converter 104, and provided to the processor 106 via the interface 114.

In general, the interface protocol converter 104 is shown as a separate element, but may be incorporated into the host computer 102, depending on the implementation. The interface protocol converter 104 allows the debug software running on the host computer 102 to communicate with the processor 106. In general, the host computer 102 includes a processor executing a debug software application or debug system to issue high-level commands (such as breakpoints, watchpoints, and the like) and to examine the contents of memory of the processor 106. The debug software can use the interface protocol converter 104 to access scan chains to debug the processor 106. The scan chains allow the debug software of the host computer 102 to insert instructions directly into the processor 106. The instructions are executed on the processor 106 and depending on the type of instruction, the state of the processor 106 may be examined, saved or changed. In general, the debug architecture provides a means for controlling a speed of execution of the instructions on the processor 106, such that instructions can be executed at a slow debug speed, at system speed, or at other speeds. Additionally, the debug architecture 100 allows a user/operator to monitor the execution of processor readable instructions within the processor to debug the processor, the processor readable instructions, or any combination thereof.

The JTAG interface 108 of the processor 106 provides access by the host computer 102 to the scan chains for debug operations of the processor 106. Additionally, the JTAG interface 108 provides access by the host computer 102 to system state data and to debug data of the processor 106. In general, the processor 106 does not need to be running to begin debug operations. In a halt debug mode, the debug extensions allow the host computer 102 to put the processor 106 into a debug state, allowing the internal state of the processor 106 to be examined, while other system activity may be allowed to proceed. In a monitor debug mode, an instruction abort can be generated on a breakpoint or a watchpoint to debug the processor 106 without entering the halt debug mode. When utilized in conjunction with a debug monitor software application running on the host computer 102, it is possible to debug the processor 106 while allowing the execution of critical interrupt service routines.

The host computer 102 includes a memory 120, processor readable instructions 122 defining software debug system, and a processor 124. The processor 124 is adapted to access the memory 120 and to execute the processor readable instructions 122 to produce a debug software application with a graphical debugger user interface 126. A user may interact with the graphical user interface 126 to initiate debug operations on the processor 106, to define settings for the debug operations, and to monitor the progress of the debug operations. The memory 120 may be used to store debug settings, processor state data, and debug register data when a power collapse occurs during a debug operation. The debug software application running on the host computer 102 can utilized the data stored in the memory 120 to restore debug registers and other debug settings of the processor 106 when power is restored. In one embodiment, one of the debug registers is a debug configuration register that is testable when the processor executes in a supervisor mode, and that is not testable when the processor executes in a user mode.

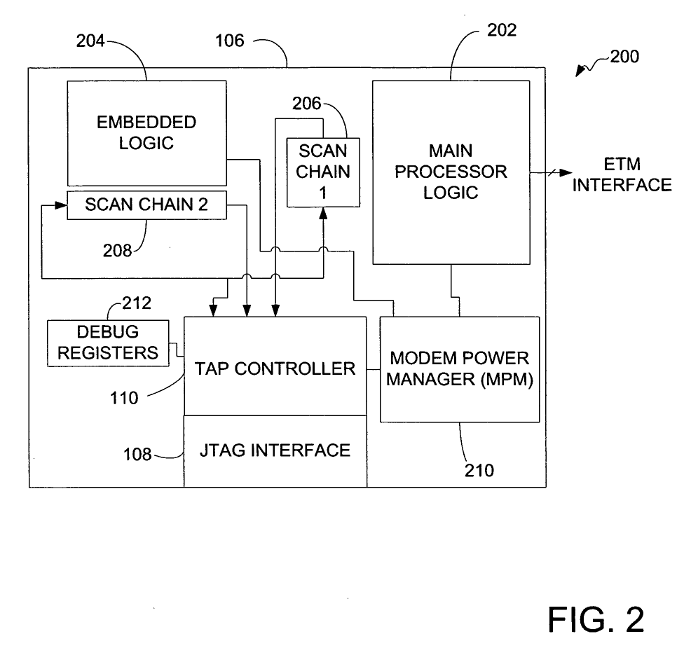

FIG. 2 is a block diagram 200 of a representative processor 106 with a modem power manager 210. The processor 106 includes a JTAG interface 108, a TAP controller 110, main processor logic 202, embedded logic 204, scan chains 206 and 208, a modem power manager (MPM) 210, and debug registers 212. In general, the JTAG interface 108 is adapted to connect to a host debugger system (such as host computer 102 in FIG. 1) via the interface protocol converter 104. The JTAG interface 108 receives instructions and provides the instructions to the TAP controller 110, which controls debug operations within the processor 106. In particular, the host debugger system can insert instructions into the processor 106 via the TAP controller 110, by accessing the scan chains 206 and 208.

The MPM 210 is adapted to control the entry and exit of a power-saving feature, such as the power collapse mode. A power collapse is a power-related event where the power regulator that controls the voltage of the digital logic domain (VDD_DIG) is shut off. By shutting off the power regulator, the static or standby current consumption of the processor (and of associated circuitry) is reduced. Though the MPM 210 is powered during the power collapse mode, the state of any registers outside of the MPM 210 may be unknown after a power collapse. Therefore, after a power collapse, the MPM 210 asserts a reset signal to initialize internal processor cores, such as the main processor logic 202 and embedded logic 204. The reset includes an assertion of a reset debug logic (TRST_n) signal to reset the debug logic.

Since debug registers 212 of the processor 106 reside in the power collapsed domain, the debug registers 212 lose state and need to be restored when power is restored. In order to restore the state of the debug registers 212, the main processor logic 202 and the embedded logic 204 are placed into debug mode, and the debugger application on the host computer 102, for example, restores the debug registers 212 from memory 120 and restarts the processor 106.

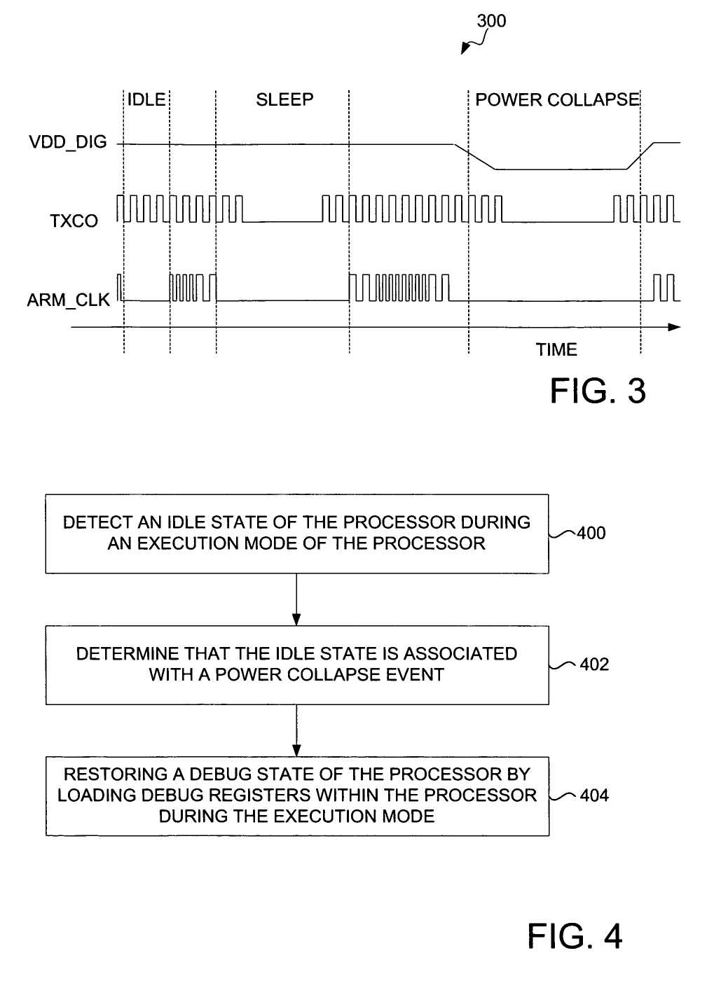

FIG. 3 is a portion of a timing diagram 300 illustrating an idle state, a sleep state, and a power collapse state with respect to a processor clock, a reference clock, and a power supply. In general, the idle state, the sleep state, and the power collapse state represent three different low-power or power-saving modes that the processor 106 can enter and that prevent or suspend JTAG communications. In any of the three states, scans of the JTAG registers fail because the ARM clock is frozen (e.g. not toggling). In the ARM9-S core, for example, the debug register scans are driven by the ARM clock gated by the reference clock (TCK). The debugger application running on the host computer 102 is adapted to distinguish between the three power saving states.

As shown in FIG. 3, during an idle state, the voltage supply (VDD_DIG) is high, the reference clock (TCXO) is toggling, and the processor clock (ARM_CLK) is idle. The idle state saves power when there is no work to be performed by the processor. In most cases, the idle state lasts for a relatively short period of time, until an interrupt is received. The interrupt enables or reactivates the processor clock within a few clock periods. Depending on the implementation, a debug instruction to a processor may be processed in different ways. In one implementation, the processor enters the idle state regardless of whether a debug instruction is present. In another implementation, the processor finishes a current scan and waits until the debug instruction is deasserted before entering an idle state. Some processors will enable the processor clock on receipt of a debug instruction when in an idle state.

During a sleep state or mode, the voltage supply (VDD_DIG) is high, the reference clock (TXCO) becomes idle after a few clock cycles, and the processor clock (ARM_CLK) is idle. The sleep mode or state saves processor and bus power during long periods of processor inactivity. For example, in a processor within a digital wireless phone (cellular, PCS, or other type of wireless telephone), there may exist long periods of inactivity when the phone is on but not being used. In most cases, the sleep mode lasts for a longer period of time than the idle mode. During a sleep mode, a received debug instruction is ignored until the next interrupt is received, at which point the processor decides to service the interrupt and/or to respond to the received debug instruction.

During a power collapse state, the supply voltage (VDD_DIG) is low, the reference clock (TXCO) becomes idle after a few clock cycles, and the processor clock (ARM_CLK) is idle. The power collapse state saves power by shutting off the digital power supply voltage (VDD_DIG) during long in-active periods. To enter a power collapse state, the processor disables all clock regimes, turns off all phase locked loops (PLLs), puts the SDRAM in a self-refresh mode, disables the processor and bus clocks, disables the reference clock (TXCO), freezes the input/output (I/O) of the chip, and turns off the voltage supply regulator.

The power collapse mode lasts longer than a second unless a high priority interrupt is received. If a debug instruction is received while the processor is in a power collapse state, the debug instruction is ignored until a next interrupt is received. Once the interrupt is received, the reference clock (TXCO) is enabled, the voltage supply regulator (VDD_DIG) is powered up, a reset is asserted, and the ARM and bus clocks are restarted. A resynchronized timing clock (RTCK) is restarted, and the debugger software of the host computer restores the debug registers within approximately 4 milliseconds before the input/output (I/O) of the chip is released.

In general, the resynchronized timing clock (RTCK) is a re-synchronized, delayed version of the timing clock (TCK). The debugger can be configured to utilize the RTCK. When the processor is halted, the RTCK signal is frozen at a high level or at a low level, regardless of which low-power mode the processor is in. The RTCK timeout may be configured or user programmed. In a particular embodiment, the RTCK timeout setting is configured to be long enough such that most idle periods do not trigger a timeout and such that standard sleep periods do trigger the timeout.

In general, if the power collapse duration is shorter than an RTCK timeout period, the current scan can be corrupted. However, since the debugger is assumed to be scanning status registers only, the scan corruption should not be an issue. If the idle state duration causes an RTCK timeout, some garbage may be left in the shift registers after the clocks are reactivated. However, the debugger can safely abort the scan and move on since the scan is assumed to be a status register read operation.

When the last reference clock edge does not appear on a resynchronized timing clock (RTCK) pin of the processor within the timeout period, a current scan of the debugger may be aborted, and the debugger sets the TAP controller to a debug logic reset state. In general, the RTCK timeout may be determined based on expiration of a clock timer. In one embodiment, the debug logic reset state can be set by holding a voltage level on a core reset pin high for five reference clock cycles. When the next resynchronized timing clock (RTCK) signal is detected, the processor has resumed operation. If an RTCK timeout occurs at any point during the transition to the debug logic reset state, the process is restarted.

Once the TAP controller is in a debug logic reset state, the debug system can perform scans of the status register. The status register value will determine the current state of the processor. If the current state of indicated by the status register indicates that the processor is running, the processor may be in a sleep or idle mode and the debugger takes no further action. If the status register indicates that the processor is halted, the halted operation could be due to a user breakpoint (idle mode or sleep mode), in which case the debugger performs the usual steps in response to a user breakpoint. If the processor is halted due to a debug instruction (EDBGRQ) from power collapse recovery logic within the modem power manager (MPM), the debugger restores the debug registers, the ETM registers, the ETB registers, or any combination thereof, within 4 milliseconds. Once the debug registers are restored, the debugger releases the debug acknowledge (DBGACK) to restart the processor.

FIG. 4 is a flow diagram illustrating a method of restoring debug registers after a power collapse. An idle state of the processor is detected during an execution mode of the processor (block 400). It is determined that the idle state is associated with a power collapse event (block 402). A debug state of the processor is restored by reloading the debug registers within the processor during the execution mode (block 406). In one embodiment, the processor is in an idle state for at least 500 milliseconds before the processor detects an idle state.

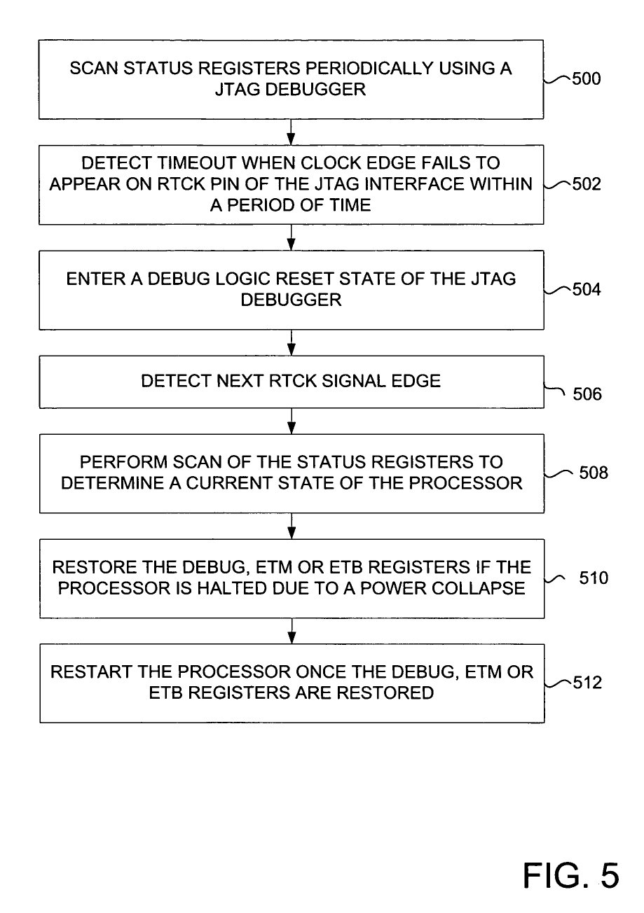

FIG. 5 is a flow diagram illustrating a method of detecting a power collapse of the processor and of restoring debug data upon restoration of power to the processor. The status registers of the processor are scanned using a debugger (block 500). A timeout condition is detected when the clock edge of the reference clock fails to appear on the resynchronized timing clock (RTCK) pin of the JTAG interface within a period of time (block 502). The debugger enters a debug logic reset state (block 504). The debugger detects a next RTCK signal edge (block 506), which indicates that the processor has become active again. The debugger scans the status registers to determine a current state of the processor (block 508). If the debugger determines that the processor was halted due to a power collapse, the debugger restores the debug registers, the ETM registers, the ETB registers, or any combination thereof (block 510), typically within 4 milliseconds. The debugger restarts the processor once the registers are restored (block 512).

In general, the modem power manager (MPM) may be integrated with an integrated circuit, such as a circuit within a mobile communications device having a power collapse debug functionality. A register bit (DEBUG_SELECT) of the MPM enables the power collapse debug functionality. In a particular embodiment, all JTAG inputs/outputs (I/Os) are frozen during a power collapse and unfrozen when the digital voltage power supply (VDD_DIG) is stabilized and the reset is released.

The MPM asserts a reset debug logic signal (TRST_N) to the processor core. During power collapse recovery, the MPM asserts an external debug request (MPM_EDBGRQ). In a particular embodiment, the processor is halted upon receipt of the external debug request within five reference clock cycles. The debug acknowledge (DBGACK) is asserted when the external debug request is detected and the processor is halted. By keeping the number of clock cycles low, the processor executes fewer instructions before detecting the debug request and halting.

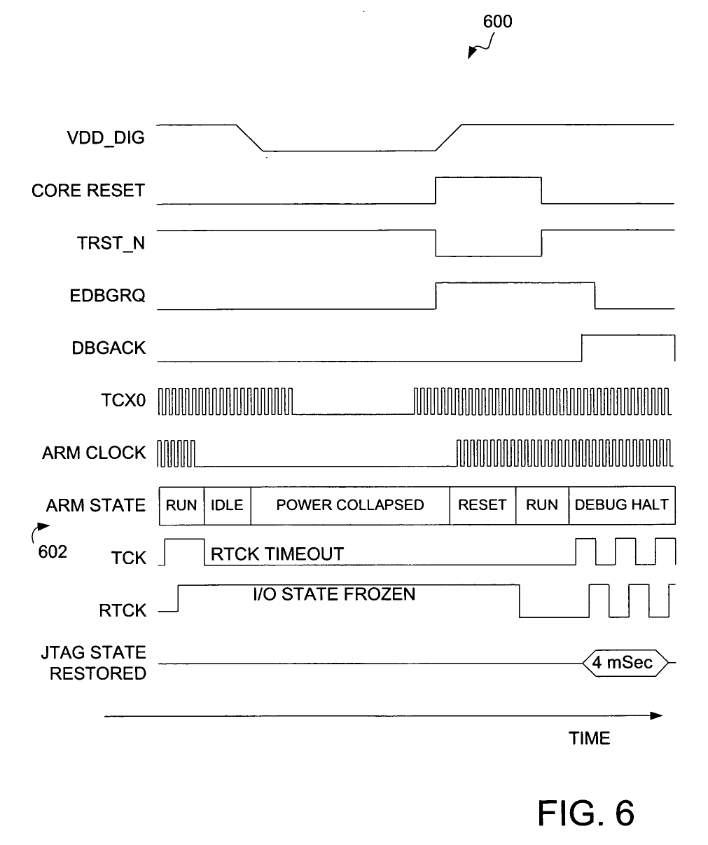

FIG. 6 illustrates a portion of a timing diagram 600 that shows a set of signals during several modes of operation of the processor. In particular, the timing diagram illustrates signals on various pins of a 20-pin Joint Test Action Group (JTAG) interface. In general, these pins may be utilized to detect a power collapse state and to execute a power collapse recovery to restore debug registers. As shown, the ARM state of the processor is indicated at 602.

During a run state, the digital supply voltage (VDD_DIG) to the processor is high, the reset is held at logic low, and the reset debug logic (TRST_N) is held at logic high. The external debug request (EDBGRQ) pin and the debug acknowledge pin (DBGACK) are held at logic low. The reference clock (TCXO) and the processor clock (ARM_CLK) are toggling. The timing clock (TCK) and the resynchronized timing clock (RTCK) are toggling.

When the processor changes to an idle state, the digital supply voltage (VDD_DIG) to the processor falls below the level of the run state. The reset is held at logic low, and the reset debug logic (TRST_N) is held at logic high. The external debug request (EDBGRQ) pin and the debug acknowledge pin (DBGACK) are held at logic low. The reference clock (TCXO) is toggling. However, the processor clock (ARM_CLK) is halted. The timing clock (TCK) is halted and the resynchronized timing clock (RTCK) remains frozen.

When the processor changes to a power collapse state, the digital supply voltage (VDD_DIG) to the processor is shut off (falls to approximately zero volts). The reset is held at logic low, and the reset debug logic (TRST_N) is frozen at logic high. The external debug request (EDBGRQ) pin and the debug acknowledge pin (DBGACK) are frozen at logic low. The reference clock (TCXO) toggles for a few clock cycles and then halts. The processor clock (ARM_CLK) remains halted. The timing clock (TCK) is halted, and the resynchronized timing clock (RTCK) remains frozen.

As the digital voltage supply (VDD_DIG) is restored, the processor enters a power collapse recovery state or reset state. The core reset pin is driven to a logic high, and the reset debug logic pin is driven to a logic low. The external debug request (EDBGRQ) is driven to a logic high, while the debug acknowledge pin (DBGACK) remains at logic low. The reference clock (TCXO) begins toggling, while the processor clock (ARM_CLK) remains halted. The timing clock (TCK) remains halted, and the resynchronized timing clock (RTCK) remains frozen.

After a brief period of time, the digital supply voltage (VDD_DIG) is restored to a stable high voltage level, which typically corresponds to a run state of the processor. However, the processor is still in a reset state. At this point, the processor clock (ARM_CLK) begins toggling. The core reset pin is driven to logic low, and the reset debug logic pin (TRST_N) is driven to a logic high.

At this point, the processor enters a run state. The resynchronized timing clock (RTCK) becomes unfrozen. The JTAG debug system can utilize the falling edge of the resynchronized timing clock (RTCK) to enter a JTAG wait mode to monitor a state of the timing clock (TCK) pin to detect when the processor has exited the idle, sleep or power collapse states.

After a few clock cycles, the processor enters a debug halt state (upon detection of the logic high state of the external debug request pin (EDBGRQ) by the processor). The JTAG debug system monitors the timing clock (TCK) for a rising edge. Once the rising edge of the timing clock (TCK) is detected, the JTAG debug system halts the processor and queries or scans the status registers to determine the state of the processor. The debug acknowledge pin (DBGACK) is driven to a logic high, and the external debug request pin (EDBGRQ) is driven to logic low. At this point, if the JTAG debug system determines that the processor is recovering from a power collapse, the JTAG debug system restores the debug state, including the state of the debug registers, including breakpoints and watchpoints, from memory. The restore operation takes place while the debug acknowledge pin (DBGACK) is held at logic high. Preferably, the restore operation is completed within approximately four milliseconds.

Once the debug registers and the pre-power collapse state of the processor have been restored by the JTAG debug system, the JTAG debug system releases the logic level of the debug acknowledge pin (DBGACK), thereby restarting normal processor execution in the debug mode, according to the debug settings. The JTAG debug system can then perform debug operations on the processor using at least one of the restored debug registers. For example, if the debug operations were configured for slow processor execution, the processor would resume the slow execution.

By using the static resynchronized timing clock (RTCK) to detect the change of state of the processor and to trigger a scan of the processor state by the JTAG debug system, the existing 20-pin JTAG interface, such as that shown in FIGS. 1 and 2, may be utilized to perform debug operations through a power collapse and power recovery process without the addition of side-band signals.

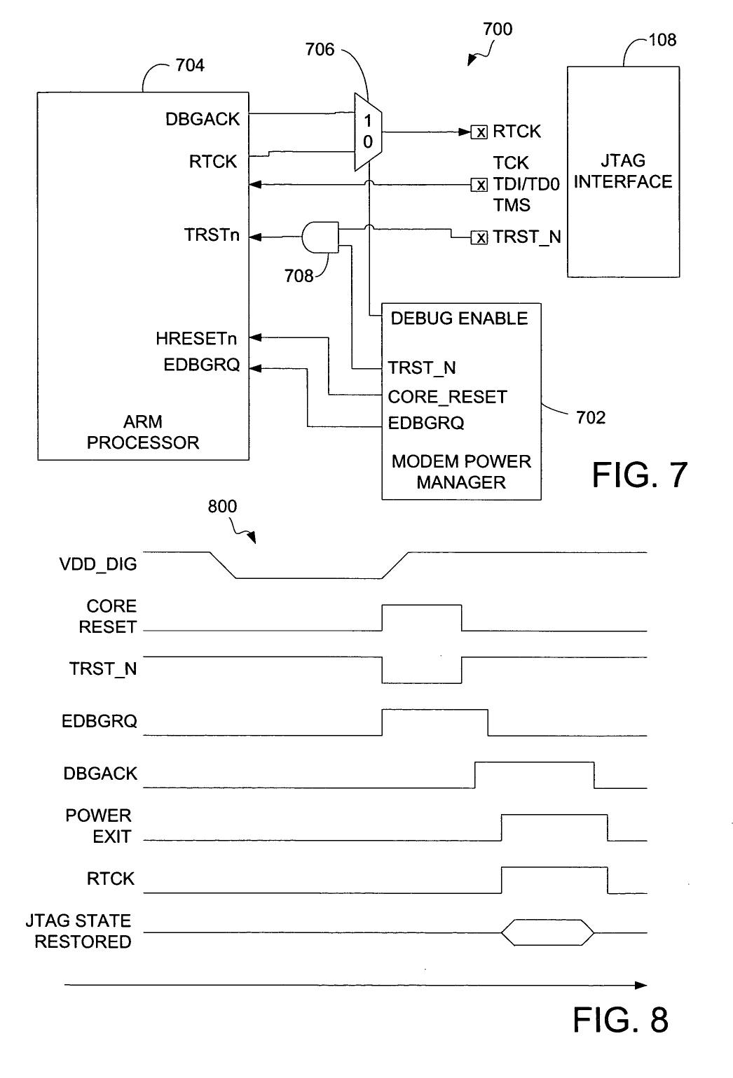

FIG. 7 is a block diagram 700 of a debug interconnection between a processor 704, the JTAG interface 108, and a modem power manager (MPM) 702. The JTAG interface 108 is shown with three connection pins to the processor 704. It should be understood that the JTAG interface includes 20-pins for interconnecting with the processor 704; however, to simplify the discussion, only three of the connections are shown in connection with the debugging of the power collapse and recovery process. The JTAG interface 108 allows the host debug system to scan the timing clock pin (TCK) and the resynchronized timing clock pin (RTCK). Additionally, the JTAG interface 108 is connected to the reset debug logic pin (TRST_N) via logic 708.

In general, the MPM 702 controls the logic level of the core reset pin and the external debug request pin (EDBGRQ) of the processor 704. Since the MPM 702 shuts off the power regulator and controls the voltage of the digital logic domain, the MPM 702 knows when to assert the reset debug logic (TRST_N) into the processor 704. Additionally, during power collapse recovery, the MPM 702 asserts the external debug request (EDBGRQ) to the processor 704 to initiate a debug halt. Once the debug acknowledge (DBGACK) is received from the processor 704, the MPM 702 deasserts the external debug request (EDGBRQ), and the JTAG debug system can restore the state of the processor 702 and the state of selected debug registers, including breakpoints and watchpoints within the code.

In the embodiment of FIG. 7, the processor 704 may be adapted to provide a power exit signal on the debug acknowledge pin (DBGACK). In particular, the MPM 702 provides a debug enable to a multiplexer 706. When the power exit signal is at a high logic level, the processor 704 is halted in a debug mode when exiting power collapse. The power exit signal can then be routed via the multiplexer 706 to the JTAG 20-pin connector at pin 11 (resynchronized clock RTCK). During a power collapse mode, the normal resynchronized timing clock (RTCK) may be disabled in the processor 704. The user can configure the JTAG debug system to use a fixed timing clock (TCK) instead of the resynchronized timing clock (RTCK).

When the processor 704 enters a power collapse state, the JTAG signals are frozen at the current level. The JTAG debug software application running on a host processor coupled to the processor through the JTAG interface 702 may incorporate an algorithm to detect a bit sequence on the timing clock (TCK)/TDK/TDO pin to infer that a power collapse has occurred. Any partial scans by the JTAG debug system can then be aborted and the debugger can go into a JTAG wait mode to wait for an active high level on the resynchronized timing clock (RTCK) pin, which indicates that the processor 704 has exited power collapse and is halted in debug mode. The JTAG debug system can then restore debug and ETM register settings of the processor 704. It should be understood that the JTAG debug system keeps a local copy in memory of values written to the debug registers and the ETM registers in order to implement the restore operation. After the debug and ETM registers are restored, the JTAG debug system can scan instructions to cause the processor 704 to restart program execution.

In general, the JTAG debug system should retain data related to any ETM trace that was in progress before the power collapse. In general, when the processor 704 is powered down, the JTAG debug system should not generate a fatal error when the resynchronized timing clock (RTCK) is frozen. The JTAG debug system may be adapted to provide a debugger graphical user interface with a configurable timeout setting.

It should be understood that the resynchronized timing clock (RTCK) may toggle before a power collapse or after the power exit signal has been deasserted. This may occur in the case of dynamic multiplexing of the processor 702 resynchronized timing clock (RTCK) and the power exit signal, but not with static multiplexing (such as when the frozen state of the resynchronized timing clock signal is monitored to detect a frozen state and to enter a JTAG wait mode in response to the frozen state). If the MUX 706 is used to multiplex a power ext signal from the debug acknowledge (DBGACK) or from a separate power exit pin (not shown), the JTAG debug system is adapted to ignore this toggle.

Since the power exit signal represents a delayed version of the debug acknowledge (DBGACK) from the processor 704, the power exit signal should remain at a high logic level while the processor 704 is in a debug mode. In general, the power exit signal is treated as a level sensitive state bit. Therefore, it should remain at logic high long enough to be sampled by the JTAG debug system. In a particular embodiment, the power exit signal should remain at logic high for at least twenty microseconds. If the processor 704 deasserts the debug acknowledge (DBGACK) for short periods of time while in a debug mode, it may be desirable to provide a control bit in the JTAG scan chain (such as scan chains 206 and 208 in FIG. 2) of the processor to force the debug acknowledge (DBGACK) to logic high while in the debug mode.

FIG. 8 is a portion of a timing diagram 800 illustrating a set of signals used to diagnose a power collapse state and to restore debug registers upon restoration of the power supply to the processor of FIG. 7. Upon recovery from the power collapse, the digital voltage supply (VDD_DIG) rises. The core reset pin is driven to a logic high and the reset debug logic (TRST_N) is driven to logic low. The modem power manager drives an external debug request pin (EDBGRQ) to logic high.

After the digital voltage supply stabilizes in a high state, the core reset pin is driven to logic low, and the reset debug logic pin is driven to logic high. With the falling edge of the reset signal, the processor detects that the external debug request (EDBGRQ) pin is at logic high. The processor drives a debug acknowledge signal to a logic high level. At this point, the modem power manager drives the external debug request pin (EDBGRQ) to a logic low level, and the processor drives a power exit pin to a logic high. The logic high state of the power exit can be detected by the JTAG debug system on the resynchronized timing clock (RTCK) pin, for example. The multiplexer 706 (in FIG. 7) can multiplex a power exit signal onto the RTCK pin. The change of state of the RTCK pin can thus be used to detect the power collapse, and the JTAG debug system can restore the state of the debug and ETM registers.

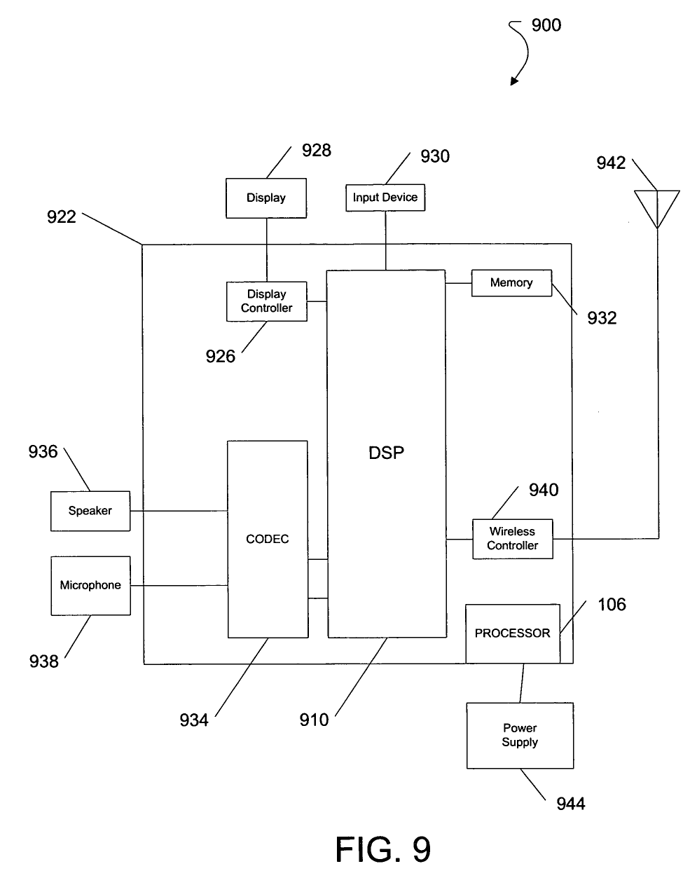

FIG. 9 illustrates an exemplary, non-limiting embodiment of a portable communication device that is generally designated 900. As illustrated in FIG. 9, the portable communication device includes an on-chip system 922 that includes a digital signal processor 910. FIG. 9 also shows a display controller 926 that is coupled to the digital signal processor 910 and a display 928. Moreover, an input device 930 is coupled to the digital signal processor 910. As shown, a memory 932 is coupled to the digital signal processor 910. Additionally, a coder/decoder (CODEC) 934 can be coupled to the digital signal processor 910. A speaker 936 and a microphone 938 can be coupled to the CODEC 930.

FIG. 9 also indicates that a wireless controller 940 can be coupled to the digital signal processor 910 and a wireless antenna 942. In a particular embodiment, a power supply 944 is coupled to the on-chip system 922. Moreover, in a particular embodiment, as illustrated in FIG. 9, the display 928, the input device 930, the speaker 936, the microphone 938, the wireless antenna 942, and the power supply 944 are external to the on-chip system 922. However, each is coupled to a component of the on-chip system 922.

Electronic signals representing the user's voice can be sent to the CODEC 934 to be encoded. The digital signal processor 910 is adapted to perform data processing operations for the CODEC 934 to encode the electronic signals from the microphone. Further, incoming signals received via the wireless antenna 942 may be sent to the CODEC 934 by the wireless controller 940 to be decoded and sent to the speaker 936. The digital signal processor 910 is also adapted to perform the data processing for the CODEC 934 when decoding the signal received via the wireless antenna 942.

Further, the digital signal processor 910 can process inputs that are received from the input device 930, before the wireless communication session, during the wireless communication session, after the wireless communication session, or any combination thereof. For example, during the wireless communication session, a user may utilize the input device 930 and the display 928 to surf the Internet via a web browser application that is embedded within the memory 932 of the portable communication device 900.

In general, the portable communication device 900 includes an ARM processor 106 with debug functionality, such as that described in FIGS. 1-8. The ARM processor 106 may control operation of the portable communication device 900. Additionally, the display controller 926 and the wireless controller 940 may each include a processor with debug functionality, such as that described above in FIGS. 1-8. The on-chip system 922 may include test pins (not shown) for coupling to a Joint Test Action Group (JTAG) debugger to debug the operation of the processors such as the processor 106, and such as processors within the display controller 926 and within the wireless controller 940.

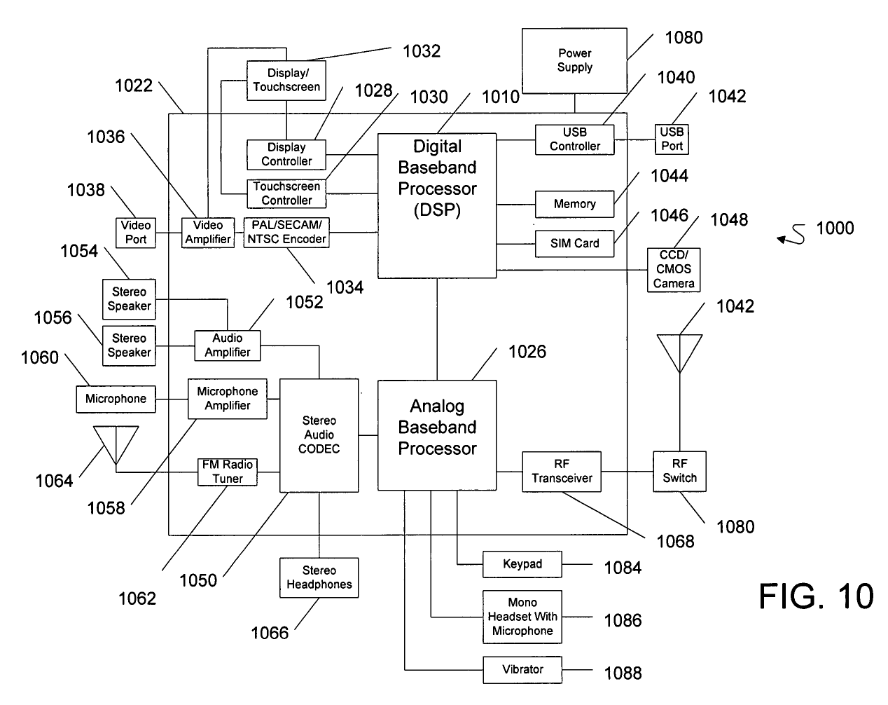

Referring to FIG. 10, an exemplary, non-limiting embodiment of a cellular telephone is shown and is generally designated 1000. As shown, the cellular telephone 1000 includes an on-chip system 1022 that includes a digital baseband processor 1010 and an analog baseband processor 1026 that are coupled together. As illustrated in FIG. 10, a display controller 1028 and a touchscreen controller 1030 are coupled to the digital baseband processor 1010. In turn, a touchscreen display 1032 external to the on-chip system 1022 is coupled to the display controller 1028 and the touchscreen controller 1030.

FIG. 10 further indicates that a video encoder 1034, e.g., a phase alternating line (PAL) encoder, a sequential couleur a memoire (SECAM) encoder, or a national television system(s) committee (NTSC) encoder, is coupled to the digital baseband processor 1010. Further, a video amplifier 1036 is coupled to the video encoder 1034 and the touchscreen display 1032. Also, a video port 1038 is coupled to the video amplifier 1036. As depicted in FIG. 10, a universal serial bus (USB) controller 1040 is coupled to the digital baseband processor 1010. Also, a USB port 1042 is coupled to the USB controller 1040. A memory 1044 and a subscriber identity module (SIM) card 1046 can also be coupled to the digital baseband processor 1010. Further, as shown in FIG. 10, a digital camera 1048 can be coupled to the digital baseband processor 1010. In an exemplary embodiment, the digital camera 1048 is a charge-coupled device (CCD) camera or a complementary metal-oxide semiconductor (CMOS) camera.

As further illustrated in FIG. 10, a stereo audio CODEC 1080 can be coupled to the analog baseband processor 1026. Moreover, an audio amplifier 1082 can coupled to the to the stereo audio CODEC 1080. In an exemplary embodiment, a first stereo speaker 1084 and a second stereo speaker 1086 are coupled to the audio amplifier 1082. FIG. 10 shows that a microphone amplifier 1088 can be also coupled to the stereo audio CODEC 1080. Additionally, a microphone 1060 can be coupled to the microphone amplifier 1088. In a particular embodiment, a frequency modulation (FM) radio tuner 1062 can be coupled to the stereo audio CODEC 1080. Also, an FM antenna 1064 is coupled to the FM radio tuner 1062. Further, stereo headphones 1066 can be coupled to the stereo audio CODEC 1080.

FIG. 10 further indicates that a radio frequency (RF) transceiver 1068 can be coupled to the analog baseband processor 1026. An RF switch 1070 can be coupled to the RF transceiver 1068 and an RF antenna 1072. As shown in FIG. 10, a keypad 1074 can be coupled to the analog baseband processor 1026. Also, a mono headset with a microphone 1076 can be coupled to the analog baseband processor 1026. Further, a vibrator device 1078 can be coupled to the analog baseband processor 1026. FIG. 10 also shows that a power supply 1080 can be coupled to the on-chip system 1022. In a particular embodiment, the power supply 1080 is a direct current (DC) power supply that provides power to the various components of the cellular telephone 1000 that require power. Further, in a particular embodiment, the power supply is a rechargeable DC battery or a DC power supply that is derived from an alternating current (AC) to DC transformer that is connected to an AC power source.

In a particular embodiment, as depicted in FIG. 10, the touchscreen display 1032, the video port 1038, the USB port 1042, the camera 1048, the first stereo speaker 1084, the second stereo speaker 1086, the microphone 1060, the FM antenna 1064, the stereo headphones 1066, the RF switch 1070, the RF antenna 1072, the keypad 1074, the mono headset 1076, the vibrator 1078, and the power supply 1080 are external to the on-chip system 1022.

In general, the on-chip system 1022 of the cellular telephone 1000 may include one or more processors with debug functionality according to any of the FIGS. 1-8. For example, the display controller 1028, the touchscreen controller 1030, and the USB controller 1040 may include processors with debug functionality, such as ARM processor 106. Additionally, a separate control processor (not shown) may be included in the on-chip system 1022 to control operation of the cellular telephone 1000. The on-chip system 1022 may include test pins (not shown) for coupling to a Joint Test Action Group (JTAG) debugger to debug the operation of the various processors.

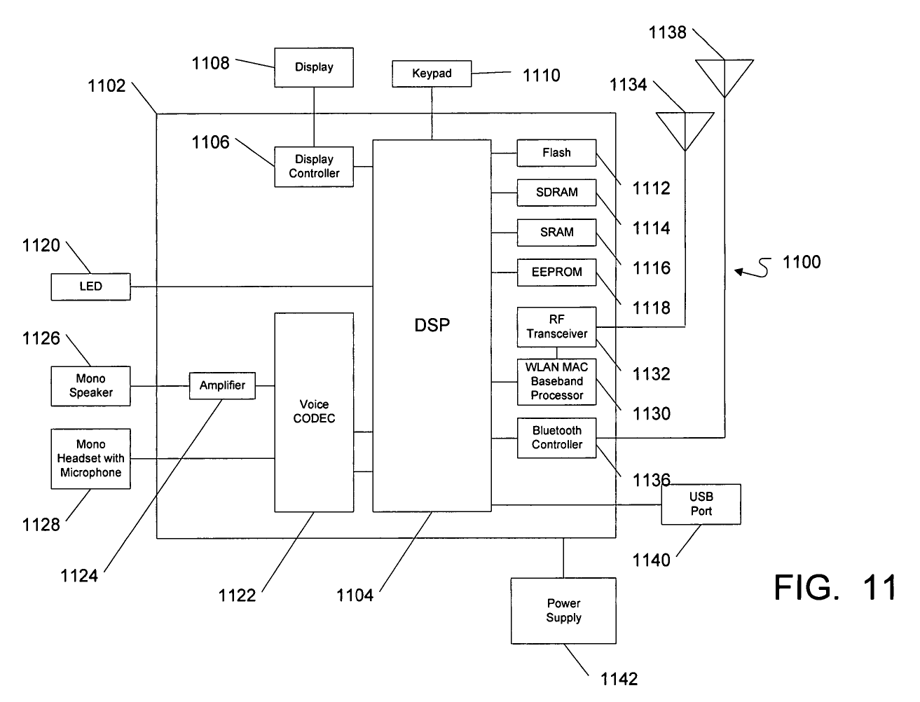

Referring to FIG. 11, an exemplary, non-limiting embodiment of a wireless Internet protocol (IP) telephone is shown and is generally designated 1100. As shown, the wireless IP telephone 1100 includes an on-chip system 1102 that includes a digital signal processor (DSP) 1104. As illustrated in FIG. 11, a display controller 1106 is coupled to the DSP 1104 and a display 1108 is coupled to the display controller 1106. In an exemplary embodiment, the display 1108 is a liquid crystal display (LCD). FIG. 11 further shows that a keypad 1110 can be coupled to the DSP 1104.

As further depicted in FIG. 11, a flash memory 1112 can be coupled to the DSP 1104. A synchronous dynamic random access memory (SDRAM) 1114, a static random access memory (SRAM) 1116, and an electrically erasable programmable read only memory (EEPROM) 1118 can also be coupled to the DSP 1104. FIG. 11 also shows that a light emitting diode (LED) 1120 can be coupled to the DSP 1104. Additionally, in a particular embodiment, a voice CODEC 1122 can be coupled to the DSP 1104. An amplifier 1124 can be coupled to the voice CODEC 1122 and a mono speaker 1126 can be coupled to the amplifier 1124. FIG. 11 further indicates that a mono headset 1128 can also be coupled to the voice CODEC 1122. In a particular embodiment, the mono headset 1128 includes a microphone.

FIG. 11 also illustrates that a wireless local area network (WLAN) baseband processor 1130 can be coupled to the DSP 1104. An RF transceiver 1132 can be coupled to the WLAN baseband processor 1130 and an RF antenna 1134 can be coupled to the RF transceiver 1132. In a particular embodiment, a Bluetooth controller 1136 can also be coupled to the DSP 1104 and a Bluetooth antenna 1138 can be coupled to the controller 1136. FIG. 11 also shows that a USB port 1140 can also be coupled to the DSP 1104. Moreover, a power supply 1142 is coupled to the on-chip system 1102 and provides power to the various components of the wireless IP telephone 1100 via the on-chip system 1102.

In a particular embodiment, as indicated in FIG. 11, the display 1108, the keypad 1110, the LED 1120, the mono speaker 1126, the mono headset 1128, the RF antenna 1134, the Bluetooth antenna 1138, the USB port 1140, and the power supply 1142 are external to the on-chip system 1102. However, each of these components is coupled to one or more components of the on-chip system.

In general, the wireless IP telephone 1100 may include an ARM processor with debug functionality according any of the FIGS. 1-8 above. In one embodiment, the wireless IP telephone 1100 includes a control processor (not shown) to control the operation of the wireless IP telephone 1100. Additionally, the display controller 1106 and the bluetooth controller 1136 may include a processor with debug functionality, such as the ARM processor 106 according to any of the FIGS. 1-8. The on-chip system 1102 may include test pins (not shown) for connection with a Joint Test Action Group (JTAG) debugger system to debug the various processors.

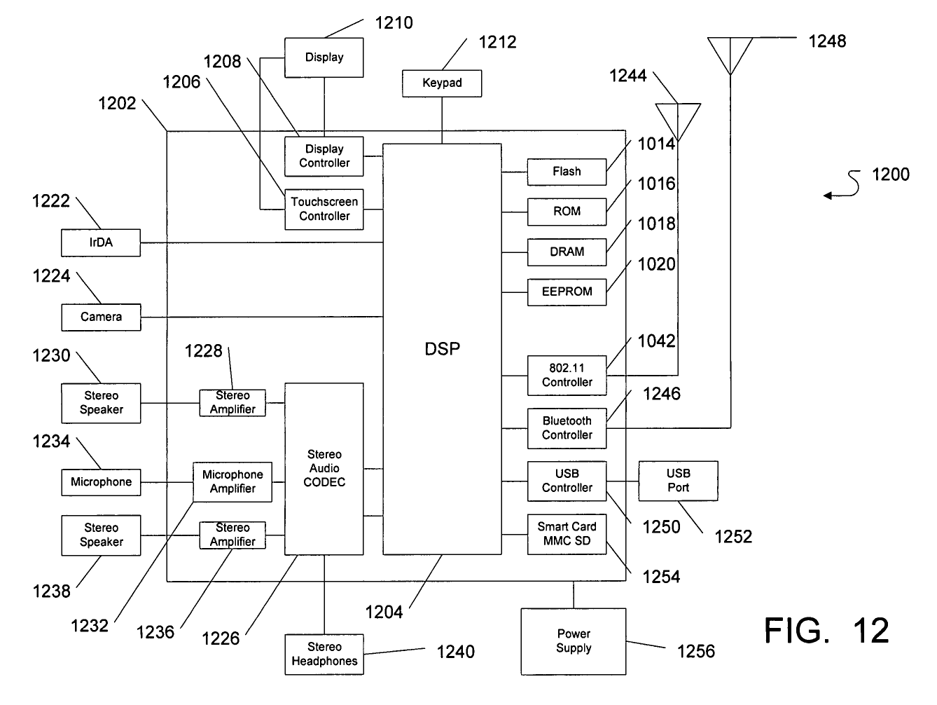

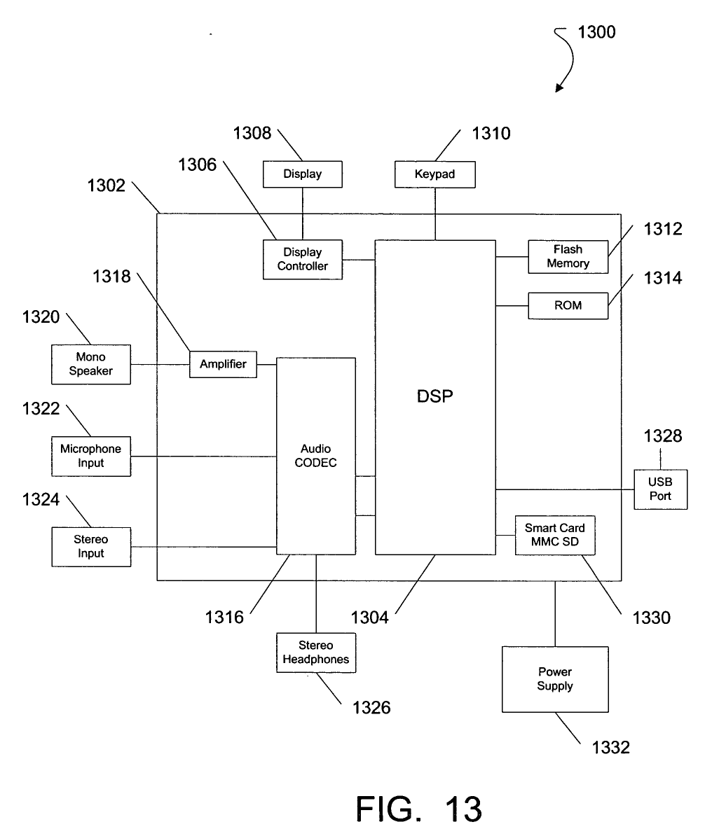

FIG. 12 illustrates an exemplary, non-limiting embodiment of a portable digital assistant (PDA) that is generally designated 1200. As shown, the PDA 1200 includes an on-chip system 1202 that includes a digital signal processor (DSP) 1204. As depicted in FIG. 12, a touchscreen controller 1206 and a display controller 1208 are coupled to the DSP 1204. Further, a touchscreen display is coupled to the touchscreen controller 1206 and to the display controller 1208. FIG. 12 also indicates that a keypad 1212 can be coupled to the DSP 1204.

As further depicted in FIG. 12, a flash memory 1214 can be coupled to the DSP 1204. Also, a read only memory (ROM) 1216, a dynamic random access memory (DRAM) 1218, and an electrically erasable programmable read only memory (EEPROM) 1220 can be coupled to the DSP 1204. FIG. 12 also shows that an infrared data association (IrDA) port 1222 can be coupled to the DSP 1204. Additionally, in a particular embodiment, a digital camera 1224 can be coupled to the DSP 1204.

As shown in FIG. 12, in a particular embodiment, a stereo audio CODEC 1226 can be coupled to the DSP 1204. A first stereo amplifier 1228 can be coupled to the stereo audio CODEC 1226 and a first stereo speaker 1230 can be coupled to the first stereo amplifier 1228. Additionally, a microphone amplifier 1232 can be coupled to the stereo audio CODEC 1226 and a microphone 1234 can be coupled to the microphone amplifier 1232. FIG. 12 further shows that a second stereo amplifier 1236 can be coupled to the stereo audio CODEC 1226 and a second stereo speaker 1238 can be coupled to the second stereo amplifier 1236. In a particular embodiment, stereo headphones 1240 can also be coupled to the stereo audio CODEC 1226.

FIG. 12 also illustrates that an 802.11 controller 1242 can be coupled to the DSP 1204 and an 1102.11 antenna 1244 can be coupled to the 1102.11 controller 1242. Moreover, a Bluetooth controller 1246 can be coupled to the DSP 1204 and a Bluetooth antenna 1248 can be coupled to the Bluetooth controller 1246. As depicted in FIG. 12, a USB controller 1280 can be coupled to the DSP 1204 and a USB port 1282 can be coupled to the USB controller 1280. Additionally, a smart card 1284, e.g., a multimedia card (MMC) or a secure digital card (SD) can be coupled to the DSP 1204. Further, as shown in FIG. 12, a power supply 1286 can be coupled to the on-chip system 1202 and can provide power to the various components of the PDA 1200 via the on-chip system 1202.

In a particular embodiment, as indicated in FIG. 12, the display 1210, the keypad 1212, the IrDA port 1222, the digital camera 1224, the first stereo speaker 1230, the microphone 1234, the second stereo speaker 1238, the stereo headphones 1240, the 1102.11 antenna 1244, the Bluetooth antenna 1248, the USB port 1282, and the power supply 1280 are external to the on-chip system 1202. However, each of these components is coupled to one or more components of the on-chip system 1202.

In general, the PDA 1200 may include one or more processors with debug functionality, such an ARM processor described with respect to FIGS. 1-8. The PDA 1200 includes a display controller 1208, a touchscreen controller 1206, an 802.11 controller 1042, a bluetooth controller 1246, and an USB controller 1250, each of which may include a processor with debug functionality, such as that described above with respect to FIGS. 1-8. Additionally, the PDA 1200 may include an ARM processor with debug functionality to control the operation of the PDA 1200. The on-chip system 1202 may include test pins (not shown) accessible by a JTAG debug system to access the scan chains of the various processors to perform debug operations.

Referring to FIG. 13, an exemplary, non-limiting embodiment of an audio file player, such as moving pictures experts group audio layer-3 (MP3) player is shown and is generally designated 1300. As shown, the audio file player 1300 includes an on-chip system 1302 that includes a digital signal processor (DSP) 1304. As illustrated in FIG. 13, a display controller 1306 is coupled to the DSP 1304 and a display 1308 is coupled to the display controller 1306. In an exemplary embodiment, the display 1308 is a liquid crystal display (LCD). FIG. 13 further shows that a keypad 1310 can be coupled to the DSP 1304.

As further depicted in FIG. 13, a flash memory 1312 and a read only memory (ROM) 1314 can be coupled to the DSP 1304. Additionally, in a particular embodiment, an audio CODEC 1316 can be coupled to the DSP 1304. An amplifier 1318 can be coupled to the audio CODEC 1316 and a mono speaker 1320 can be coupled to the amplifier 1318. FIG. 13 further indicates that a microphone input 1322 and a stereo input 1324 can also be coupled to the audio CODEC 1316. In a particular embodiment, stereo headphones 1326 can also be coupled to the audio CODEC 1316.

FIG. 13 also indicates that a USB port 1328 and a smart card 1330 can be coupled to the DSP 1304. Additionally, a power supply 1332 can be coupled to the on-chip system 1302 and can provide power to the various components of the audio file player 1300 via the on-chip system 1302.

In a particular embodiment, as indicated in FIG. 13, the display 1308, the keypad 1310, the mono speaker 1320, the microphone input 1322, the stereo input 1324, the stereo headphones 1326, the USB port 1328, and the power supply 1332 are external to the on-chip system 1302. However, each of these components is coupled to one or more components on the on-chip system.

In general, the audio file player 1300 may include one or more processors with debug functionality, such as the ARM processor 106 described with respect to FIGS. 1-8. The audio file player 1300 includes a display controller 1306, which may include a processor with debug functionality, such as that described above with respect to FIGS. 1-8. Additionally, the audio file player 1300 may include an ARM processor including such debug functionality, such as processor 106, to control the operation of the audio file player 1300. A JTAG debug system may access the various processors via test pins (not shown) provided on the on-chip system 1302.

Those of skill would further appreciate that the various illustrative logical blocks, configurations, modules, circuits, and algorithm steps described in connection with the embodiments disclosed herein may be implemented as electronic hardware, computer software, or combinations of both. To clearly illustrate this interchangeability of hardware and software, various illustrative components, blocks, configurations, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method or algorithm described in connection with the embodiments disclosed herein may be embodied directly in hardware, in a software module executed by a processor, or in a combination of the two. A software module may reside in RAM memory, flash memory, ROM memory, PROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a computing device or a user terminal. In the alternative, the processor and the storage medium may reside as discrete components in a computing device or user terminal.

The previous description of the disclosed embodiments is provided to enable any person skilled in the art to make or use the present disclosure. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features as defined by the following claims.

What is claimed is:

1. A method of performing a debug operation on a processor after a power collapse, the method comprising:
detecting an idle state of the processor during an execution mode of the processor;
determining that the idle state is associated with a power collapse event; and
restoring a debug state of the processor by loading debug registers within the processor during the execution mode.

2. The method of claim 1, further comprising querying a state of the processor after detecting the idle state of the processor.

3. The method of claim 1, further comprising executing a debug operation that uses at least one of the restored debug registers.

4. The method of claim 3, wherein the debug operation is one of a breakpoint and a watchpoint debug operation.

5. The method of claim 1, wherein the processor includes an ARM type of microprocessor core.

6. The method of claim 1, wherein the idle state is detected when a processor clock of the processor is inactive.

7. The method of claim 1, wherein the processor is in the idle state for at least 500 milliseconds.

8. The method of claim 1, further comprising performing a register scan using a Joint Test Action Group (JTAG) debug system to detect the idle state of the processor.

9. The method of claim 1, wherein at least one of the debug registers is a debug configuration register that is testable when the processor executes in a supervisor mode.

10. The method of claim 1, wherein a resynchronized timing clock (RTCK) signal is evaluated in connection with detecting the idle state or in connection with detecting an end of the power collapse event.

11. The method of claim 1, further comprising detecting an end of the power collapse event prior to restoring the debug state.

12. A method of performing a debug operation on a processor having a processor core, the method comprising:
detecting an idle state of the processor core during an execution mode of the processor;
providing a request for a debug operation while the processor is in the idle state;
determining that the idle state is associated with a power collapse event by querying a state of the processor while the processor is halted;
entering into a Joint Test Action Group (JTAG) wait mode;
detecting an end of the power collapse event;
restoring a debug state of the processor by loading debug registers;
detecting a debug acknowledge signal; and
performing the debug operation that was requested.

13. The method of claim 12, wherein a power signal that is associated with power supplied to the processor is turned off before entering into the JTAG wait mode.

14. The method of claim 13, further comprising detecting expiration of a clock timer prior to detecting the idle state.

15. The method of claim 12, wherein an input/output interface of the processor core is in a frozen condition prior to the end of the power collapse event.

16. The method of claim 12, wherein a Joint Test Action Group (JTAG) input/output interface of the processor core is frozen during the power collapse event and is unfrozen after detecting the end of the power collapse event.

17. The method of claim 12, wherein the debug operation is one of a breakpoint and a watchpoint debug operation.

18. The method of claim 12, wherein the processor is in the idle state for at least 500 milliseconds.

19. The method of claim 12, further comprising performing a register scan using a Joint Test Action Group (JTAG) debug system to detect the idle state of the processor.

20. A processor debugging device comprising:
means for detecting an idle state of a processor;
means for providing a request for a debug operation while the processor is in the idle state;
means for determining that the idle state is associated with a power collapse event;
means for detecting an end of the power collapse event and for restoring a debug state of the processor; and
means for performing the debug operation that was requested.

21. An integrated circuit comprising:
a debug interface to receive instructions related to a debug operation;
a debug register to store data related to the debug operation;
a modem power manager to control a digital voltage level, the modem power manager adapted to collapse the digital voltage level to conserve power during a period of processor inactivity and to restore the digital voltage level when the period of processor inactivity is ended; and
a processor responsive to the debug interface and to the modem power manager, the processor adapted to drive a power exit pin to a designated logic level in response to restoration of the digital voltage level.

22. The integrated circuit of claim 21, wherein data is restored to the debug register upon restoration of the digital voltage level.

23. The integrated circuit of claim 21, further comprising a Joint Test Action Group (JTAG) interface to connect to a debug system, the processor adapted to freeze a logic level of at least one pin of the JTAG interface in response to collapse of the digital voltage level.

24. The integrated circuit of claim 23, wherein the processor is adapted to unfreeze the logic level of the at least one pin upon restoration of the digital voltage level.

25. A debug system comprising:
an debug interface to connect to a target processor;
processor readable instructions to define debug operations and to define a user interface for user interactions; and
a processor to produce the user interface based on the processor readable instructions, the processor to control the debug operations in response to the processor readable instructions, the processor adapted to detect a power collapse state of the processor based on a change of state of a pin of the debug interface.

26. The debug system of claim 25, further comprising a memory, wherein the processor is adapted to store a state of the debug registers in the memory during the debug operations, the debug system adapted to restore the state of the debug registers from the memory in response to the change of state.

27. The debug system of claim 25 wherein the pin comprises a clock pin, and wherein the change of state comprises a rising clock edge on the clock pin after a period of inactivity.

28. A portable communication device, comprising:
a digital signal processor; and
a controller, wherein the controller comprises:
a modem power manager to control a digital voltage level, the modem power manager adapted to collapse the digital voltage level to conserve power during a period of processor inactivity and to restore the digital voltage level when the period of processor inactivity is ended; and
a processor responsive to the modem power manager and adapted to control operation of a portion of the communication device, the processor including debug functionality to provide a power collapse recovery indication in response to restoration of the digital voltage level from a collapsed power state.

29. The portable communication device of claim 28, wherein the controller and the digital signal processor are provided on an integrated circuit with test pins.

30. The portable communication device of claim 28, further comprising:
an analog baseband processor coupled to the digital signal processor;
a stereo audio coder/decoder (CODEC) coupled to the analog baseband processor;
a radio frequency (RF) transceiver coupled to the analog baseband processor;
an RF switch coupled to the RF transceiver; and
an RF antenna coupled to the RF switch.

31. A processor readable medium embodying executable instructions to perform a debug operation on a processor, the executable instructions comprising:
instructions to detect an idle state of a processor during an execution mode of the processor;
instructions to determine that the idle state is associated with a power collapse event; and
instructions to restore a debug state of the processor by loading debug registers of the processor during the execution mode.

32. The processor readable medium of claim 31, further comprising instructions to query a state of the processor after detecting the idle state of the processor.

33. The processor readable medium of claim 31, further comprising instructions to execute a debug operation that uses at least one of the debug registers.

34. The processor readable medium of claim 33, wherein the debug operation includes instructions to execute one of a breakpoint and a watchpoint debug operation.

35. The processor readable medium of claim 31, wherein the idle state is detected wherein a processor clock of the processor is inactive.

36. The processor readable medium of claim 31, further comprising instructions to perform a register scan using a Joint Test Action Group (JTAG) debug system to detect the idle state of the processor.

37. The processor readable medium of claim 31, further comprising instructions to execute a supervisor mode to test a debug configuration register of the debug registers.

38. The processor readable medium of claim 31, further comprising instructions to detect an end of the power collapse event prior to restoring the debug state.
